(19) United States
(12) Patent Application Publication
(10) Pub. No.: US 2021/0129658 A1
(43) Pub. Date: May 6, 2021

(54) ELECTRIC VEHICLE DRIVE COMBINED WITH SUSPENSION STRUT

(71) Applicant: Cy-Car, Inc., Central Point, OR (US)

(72) Inventor: William Martin Waide, Central Point, CA (US)

(21) Appl. No.: 17/088,089

(22) Filed: Nov. 3, 2020

Related U.S. Application Data
(60) Provisional application No. 62/931,701, filed on Nov. 6, 2019.

(51) Int. Cl. B60K 7/00; B60G 11/50; B60K 17/04; B60K 11/02

(52) U.S. Cl. CPC B60K 7/0007; B60G 11/50; B60K 17/043; B60K 11/02; F16H 1/14; B60G 2300/50; B60G 2202/312; B60G 2202/132; B60K 2007/0046

(57) ABSTRACT

The inventive subject matter provides apparatus, systems and methods in which a suspension strut is integrated with a motor. The suspension strut preferably includes a damper having a tube and a piston, which damper can be partially disposed below the motor, or within the motor. Wires providing electrical power to the motor are preferably positioned such that the wires do not contact the coil spring. It is also contemplated that the suspension strut can comprise a multi-stage reduction gear, and independently, can include an oil reservoir, oil circulation pump, and oil distribution pathway configure to cool the motor.

This application claims the benefit of U.S. Provisional Patent Application No. 62/931,701 filed on Nov. 6, 2019. This and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FIELD OF THE INVENTION

The field of the invention related to a suspension strut.

### BACKGROUND

The background description includes information that may be useful in understanding the present invention. It is not an admission that any of the information provided herein is prior art or relevant to the presently claimed invention, or that any publication specifically or implicitly referenced is prior art.

The increasing world-wide adoption of electric vehicles has resulted in a major effort by manufacturers to reduce manufacturing cost, parts count and weight. With the batteries accounting for the majority of the vehicle non-structural weight, and with legislated occupant protection requiring additional weight, more attention is now being paid to the drive system. These systems consist of a motor or motors, their electronic drivers, a reduction gearbox and associated drive shafts, all located within the vehicle internal chassis volume. Simplification of this drive system would provide benefits in cost and weight saving. The subject invention includes integration of the drive motor into the vehicle suspension strut, which achieves the required simplification, and also opens up new vehicle design options for the use of interior volume such as for battery placement and provision of luggage space.

The strut-type suspension, attributed to MacPherson, has been broadly adopted by the automobile industry over decades by virtue of its simplicity, technical attributes and low cost. It can be applied to the front (steering) or rear (non-steering) locations of a vehicle, and has the advantages of being light, and combining the suspension spring, damping, steering, brake and wheel attachment functions into a single unit. In addition, the sliding piston and rod within the damper tube provide beam stiffness, and its widely-spaced attachment points minimize loads into the current shell-type chassis structures.

In FIG. 3, a typical prior art production strut assembly (300) includes a damper tube (312), piston (313), piston rod (315), upper steering swivel bearing, and road spring (311) with abutments. The lower end of the damper tube (312) is attached a hub spindle, hub (323) and bearings, brake disc (322) and caliper (321), steering arm (324) and ball joint (654). Also, it is common practice to have a gas-filled chamber separated from the oil volume by floating piston (314).

FIG. 3 also identifies the axial 352, lateral 354, and vertical 356 axes of the vehicle. Reference is made to these axes in describing the orientation of components within the drive system.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Thus, there is still a need for integrating the drive motor into the vehicle suspension strut, such that opening up free space allowing to accept various design options.

### SUMMARY OF THE INVENTION

The inventive subject matter provides apparatus, systems and methods in which a suspension strut is integrated with a motor.

In preferred embodiments, a suspension strut further comprises a damper having a tube and a piston. Such damper can be partially disposed below the motor, or within the motor. Wires providing electrical power to the motor are preferably positioned such that the wires do not contact the coil spring.

It is also contemplated that the suspension strut can comprise a multi-stage reduction gear, and independently, can include an oil reservoir, oil circulation pump, and oil distribution pathway configured to cool the motor.

Various objects, features, aspects and advantages of the inventive subject matter will become more apparent from the following detailed description of preferred embodiments, along with the accompanying drawing figures in which like numerals represent like components.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

### BRIEF DESCRIPTION OF THE DRAWING

FIG. 1 is a perspective view of an electric car.

FIG. 2 is a side view of an electric car.

FIG. 3 is a perspective view of a prior art strut assembly.

FIG. 4A is a side view of a strut assembly having an integrated motor, gearbox, and hub.

FIG. 4B is a view of the upper portion of the strut assembly of FIG. 4A.

FIG. 5 is a section of the upper portion of the strut assembly of FIG. 4A.

FIG. 6 is a section view of the lower portion of the strut assembly of FIG. 4A.

FIG. 7 is a rear view of the strut assembly of FIG. 4A through a range of suspension movement.

FIG. 8 is a perspective view of a motorized strut assembly that can operate without a coil spring.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

### DETAILED DESCRIPTION

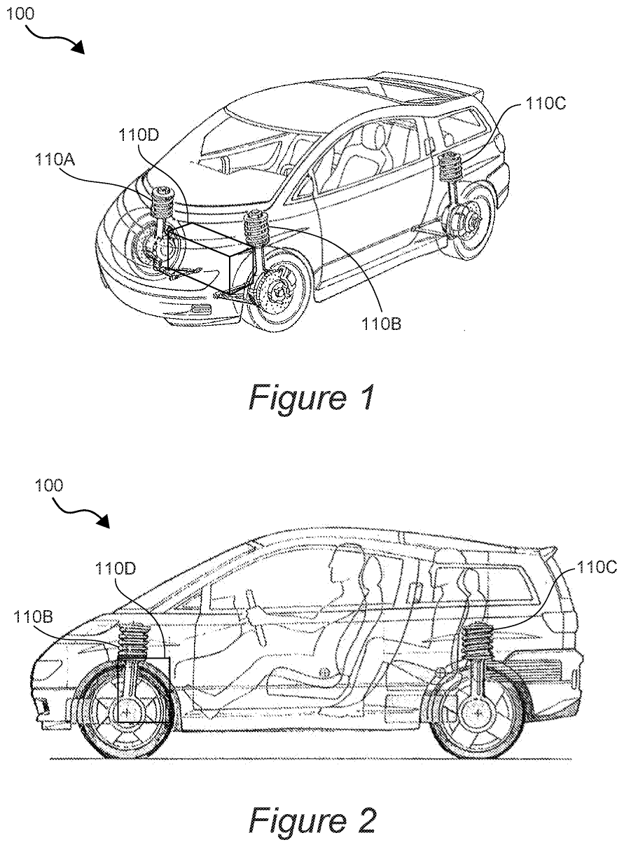

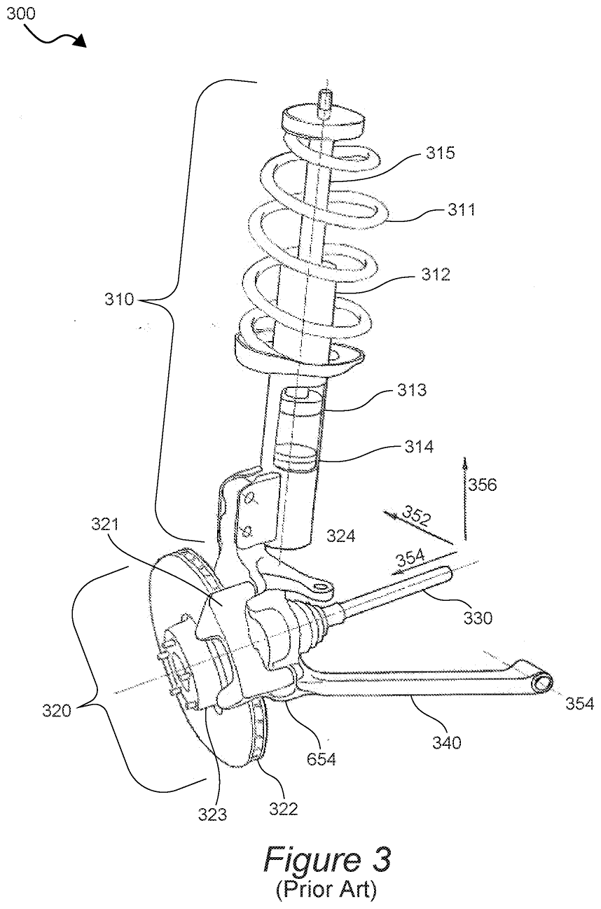

FIG. 1 shows the location of contemplated suspension struts 110A, 110B, 110C and battery 110D operationally positioned in an automobile 100, and FIG. 2 indicates interior space gained by a preferred battery 110D placement. Although not expressly depicted, contemplated commercial embodiments would likely have a fourth suspension strut on the right rear wheel of FIGS. 1 and 2, and each wheel in vehicles that have only 3 or more than four wheels.

Invention features and an expanded description of contemplated implementations are presented as an advantageous electric vehicle drive when applied in particular to light, two to four person commuting vehicles. By virtue of quality control and manufacturing methods, these vehicles, including their drive systems, can now be virtually maintenance-free.

Springs

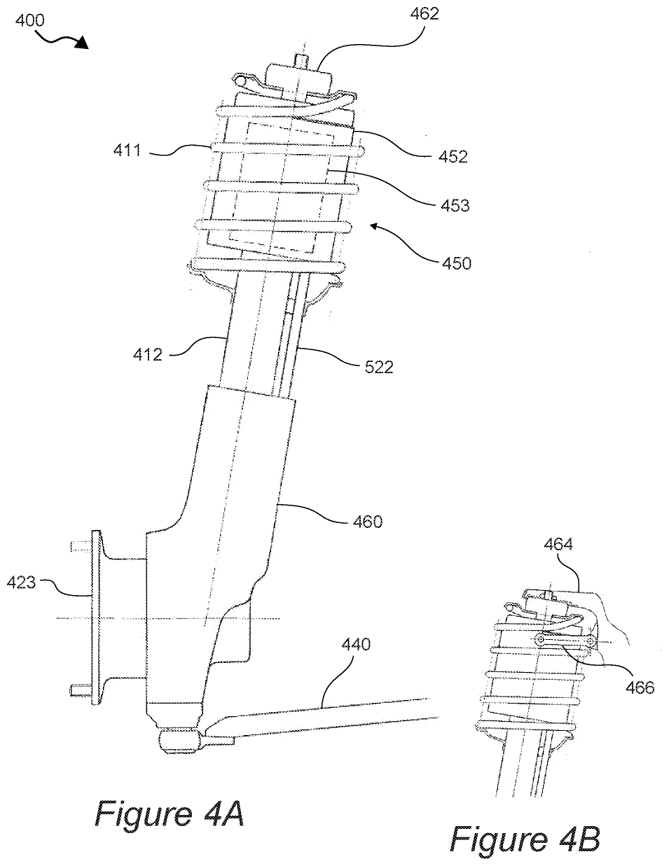

The quality and strength of spring wire material has progressively improved, resulting in springs with fewer coils, but of larger diameter. For example, in an embodiment of a preferred strut (400) depicted in FIGS. 4A and 4B, the inside diameter of the spring (411) can be larger than 5.5 inches (140 mm) and even exceed 6 inches (152 mm). The outside diameter of an electric motor (450) of sufficient power to usefully drive a single road wheel is less than these values, and preferably has a length equal to or not much exceeding the diameter. The drive motor (450) can thus be positioned within the inside volume of the road spring (411), with its axis of cylindricity parallel to the strut axis, and either concentric or eccentric to that axis.

Electric Motor

The electric motor (450) preferably has a brushless, permanent magnet design, with the magnet rotor (512) running within the stator stack (452). The torque developed by such a motor is proportional to the stack length and to the air gap diameter squared. Assigning tau (τ) to the shear force or stress at the air gap, R to the rotor radius and L to stack length, Torque=2*Pi*R^2*L*τ and volumetric power density is simply a function of RPM*t. Therefore, for best performance, the motor is required to run at a high RPM, and at the highest practical shear stress consistent with the cooling arrangement. The satisfactory result obtained from commonly used motor sizing calculations, is that a motor of useful power, e.g. 50 kW or 67 HP per wheel, can be accommodated comfortably within the road spring, and can advantageously adhere to current electric vehicle drive practice by operating with a high numerical gear ratio between the rotor and the road wheel.

The electric motor and primary drive components are located at the top of the strut (400), and can be conceptually divided into three groups of functionality. In automobile industry terms, the strut itself is a “strut insert”, namely, it is free of welded mounting appendages such as spring anchorage and hub attachment brackets. A feature of this suspension type is strut inclination as illustrated, an angle between 8 and 11 Degrees, required for minimizing the separation between the steered axis and the center of the tire contact patch, and also for minimizing the strut moments induced by vehicle weight reacting though the spring coil abutment. Clearance between the tire sidewall and strut is also a controlling dimension in the disposition of components.

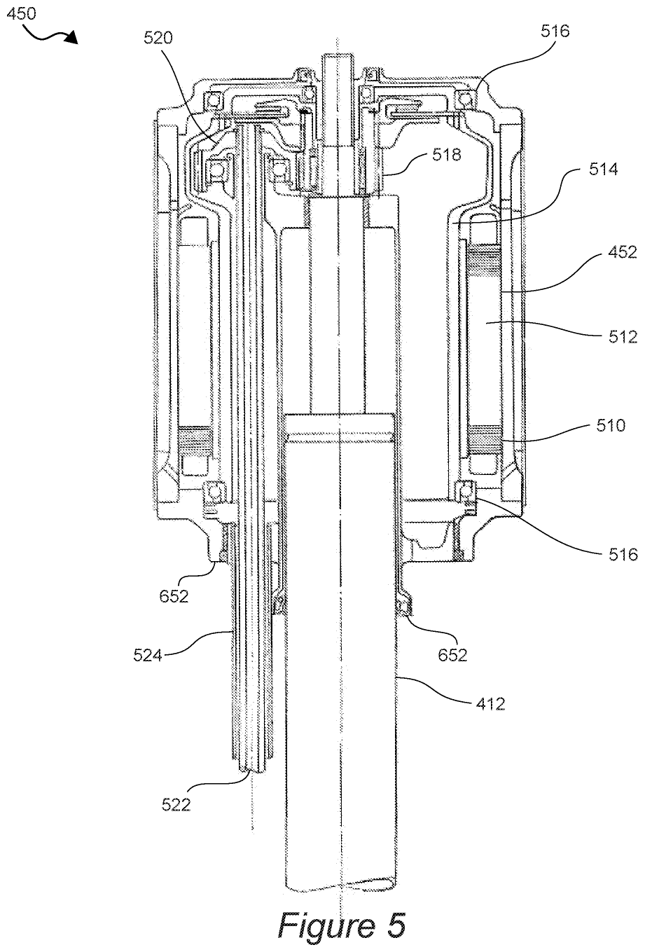

FIG. 5 is a section view of the upper portion of the strut assembly of FIG. 4A, including motor (450), having static and rotating elements, as well as cooling elements.

The Static Elements: The stator lamination stack and field winding assembly, terminating in phase connectors, does not rotationally turn with steering input into the strut and is therefore located on circular bearings. The entire motor additionally does not translate with suspension movement, being attached to the chassis (464)-attached piston rod end (non-sliding). The torque reaction from the stator is carried by a link to chassis structure.

The Rotating Elements: The steel motor rotor to which the magnet array is attached, is supported by upper bearing and lower bearing. The required pre-load across these bearings (516) is provided by wave spring. The torque from the rotor is transmitted through a torque-limiting clutch consisting of driver disc, friction material, driven disc and pressurization spring. The driven disc rotates concentrically with the rotor axis and provides the torque connection to motor primary drive gear. In order for the drive to operate within the motor confines, as the strut components cannot be penetrated, it is required to occupy the radial space between the strut tube and the inner diameter of the motor rotor, so a geared transfer drive is indicated having a center distance suitably less than the inner rotor radius and more than the strut tube outer radius.

Lubrication and Cooling: The oil system consists of oil containment within the strut lower housing, a pressure pump driven from the bevel pinion, a feed passage within the high-speed driveshaft (514), and a metering valve to distribute a small amount of lubricant to the motor bearings and primary gears and bearings, and a larger amount to the cooling fins surrounding the motor stator. Oil returns by gravity external to the strut tube but internal to the containment and sealing sleeve (524).

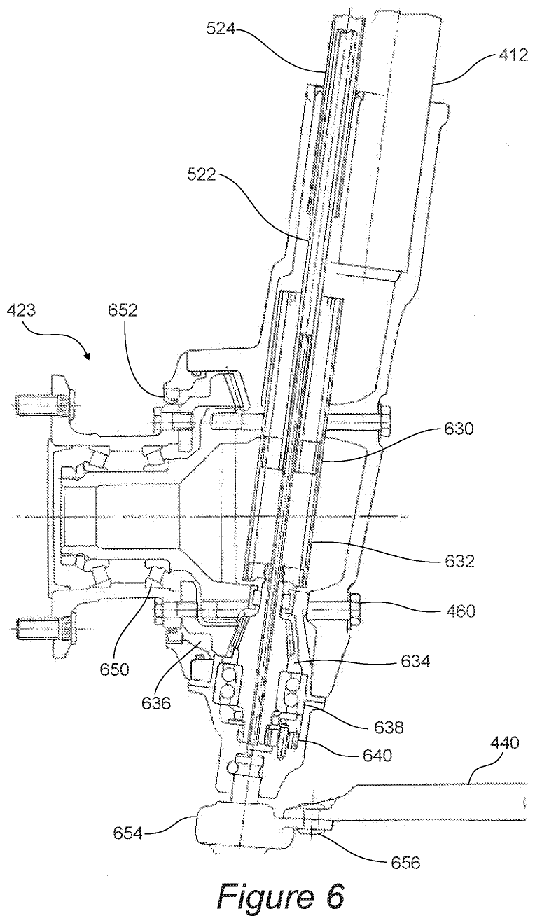

FIG. 6 is a section view of the lower portion of the strut assembly of FIG. 4A, illustrating a simple arrangement in which a fixed stub axle is bolted to gear casing, and supports rotating hub (423) by means of bearings. The ring gear (636) is mounted to the inboard flange of the hub (423) by attachment bolts and the brake disc and wheel are attached to the outboard flange of the common hub. Load-induced deflections are not experienced by the gear axes because of rigid steel member forming the connection between the stub axle and incorporating the pinion bearing (638) supports.

The lower housing provides the moment-carrying connection between the hub and strut tube, provides the mounting lugs for the brake calipers and the attachments for the lower “A” arm (440) and steering linkage.

The Strut-Located Gear Drive Elements: The overall gear ratio between the motor and road wheel is at least 9:1, could be 15:1 or even exceed 20:1. It is impractical to achieve these ratios in a single gear stage, so a primary reduction, within the confines of the motor, and a secondary reduction, in the hub (423) region at the bottom of the strut, is required. The inventive step that allows motor power via a high speed and hence small-diameter shaft to leave to confines of the motor involves the configuration of a transfer gear pair. Internal clearance for the driven gear requires that the motor rotor is configured as featured in the illustration. Motor pinion (518) running on bearing meshes with driven pinion (520) mounted on carrier by bearing which is in turn supported on tubular mount rotationally free from the piston rod but keyed to the strut tube. By this means the high speed driveshaft (524) is maintained parallel to the strut axis throughout all steering angles. The shaft operates within an oil containment)/ dirt exclusion tube (524). The shaft is tubular to permit a pressure oil feed to the motor for lubrication and cooling purposes.

Drive Interconnection between the non-translating (chassis end) and translating (road wheel end) of the strut assembly: This is accomplished by a torque-carrying slip joint assembly (630) whose axial travel is equal to or greater than the total translation movement of the strut, including full compression of attenuation rubber buffer. The male drive shaft (522) is keyed into a serrated sliding member (632) engaging with multiple spline connections featured on the inside diameter of torque tube.

Final Drive from slip joint to road wheel hub: This pair of gears (460) converts the speed and direction of drive from parallel to the strut (310) axis to the hub (423) axis of the road wheel. It consists of a bevel gear (634) driven from torque tube supported by bearing (thrust and journal loads) and by bearing (journal loads) meshing with ring gear (636). The axes of the gears are constrained by strut inclination coupled with any intended off-vertical camber setting of the road wheel.

Various combinations of gear (460) position are feasible, as would be known to designers practiced in the art of bevel gear design, but the common features of inclination and offset would remain, the differences appearing in methods of preventing road load induced deflections from influencing the accuracy of the gear mesh.

Sealing: The strut is exposed to external contaminants and in use is constantly translating due to wheel movement. As individual circular sliding members the strut containment sleeve (412) and the high speed driveshaft (524) operate within lip seals (652). For rotational sealing, the electric motor requires two lip seals and the hub a single lip seal.

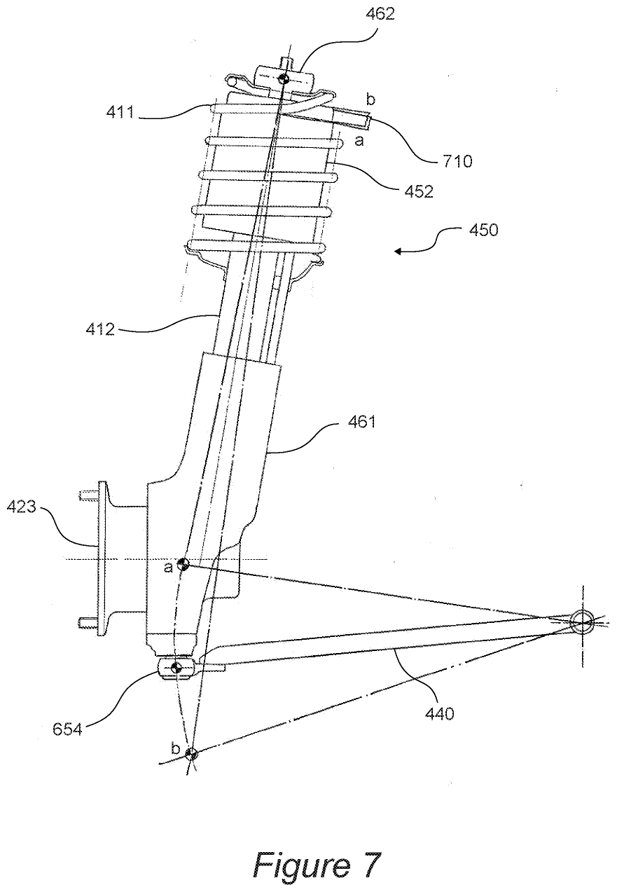

FIG. 7 is a true view of the strut assembly of FIG. 4A through a range of suspension movement, which results in the ball joint attachment (654) from the strut to the lower suspension link, or “A” arm (440), to follow arc a-b. The resulting angular displacement expressed around the upper strut attachment (462) which at maximum suspension travel range is a few degrees, is the only flexural displacement experienced by the multi-stranded current conductors and the motor cooling connections, which, by nature of their flexible construction, are not life-limited by small angles of deflection.

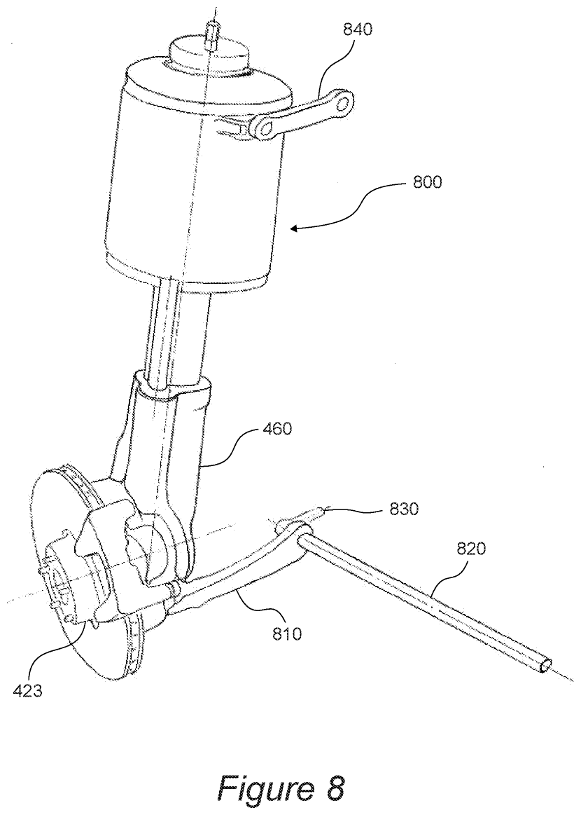

The previously described system of integrating the vehicle drive motors into the upper region of the suspension strut can be enlarged to provide substantially more power to individual wheels. In FIG. 8, the diameter of motor (800) is now larger, for example, at about 8″ for a 100 kW power, which prevents the use of an external coil spring. The suspension spring is now torsion bar (820) connected to chassis by pivot (830) and to strut and gear housing (460) by arm (810). The internal components of hub (423) are the bearings and the external components are the brake disc and brake caliper. Motor torque is reacted to chassis structure by torque link (840).

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A suspension strut having a coil spring at least partially disposed about an electric motor.

2. The suspension strut of claim 1, further comprising a damper, comprising a tube and a piston, the damper at least partially disposed below the motor.

3. The suspension strut of claim 1, further comprising a damper, comprising a tube and a piston, the damper at least partially disposed within the motor.

4. The suspension strut of claim 1, further comprising a multi-stage reduction gear.

5. The suspension strut of claim 1, further comprising wires that provide electrical power to the motor, and tubes configured to provide motor cooling fluid positioned such that the wires, tubes, and a torque link do not contact the coil spring.

6. The suspension strut of claim 1, further an oil reservoir, oil circulation pump, and oil distribution pathway configure to cool the motor.

8. An automotive vehicle having a wheel and a suspension strut that includes an electric motor, the motor positioned higher than the wheel.

9. An automotive vehicle comprising a body, the suspension strut of claim 8, and a coupling configured to restrict movement between the body and the suspension strut to no more than 1 cm.

10. The automotive vehicle of claim 8, where the suspension strut has a coil spring at least partially disposed about the electric motor.

11. The automotive vehicle of claim 8, further comprising a having a torsion bar configured to provide a spring function to the wheel, and an electric motor positioned at an upper end of the strut.
